(19) United States
(12) Patent Application Publication
(10) Pub. No.: US 2015/0100510 A1
(43) Pub. Date: Apr. 9, 2015

(54) FINDING SUITABLE JOBS USING A JOB WEBSITE

(71) Applicant: NIIT Technologies Ltd, New Delhi (IN)

(72) Inventor: Puneet Sachdev, Bangalore (IN)

(21) Appl. No.: 14/297,641

(22) Filed: Jun. 6, 2014

(30) Foreign Application Priority Data
Oct. 8, 2013 (IN) 2999/DEL/2013

(51) Int. Cl. G06Q 10/10

(52) U.S. Cl. CPC G06Q 10/1053
USPC 705/321

(57) ABSTRACT

A repository of job postings organized with multiple dimensions is maintained, with each job posting being associated with values for one or more dimensions. A corresponding group of values for each of a set of dimensions are identified such that each value has at least one available job posting in the repository. A user interface definition is then sent to an end user system, the user interface definition when rendered on a display unit of the end user system provides an input user interface to a job seeker, the input user interface containing a set of viewports, each viewport corresponding to a dimension of the set of dimensions and showing the group of values for the dimension. The display of the “job universe” reflecting the currently available jobs in the repository facilitates the job seeker to find suitable jobs more effectively when interacting with job websites.

### PRIORITY CLAIM

The instant patent application is related to and claims priority from the co-pending India patent application entitled, “PROVIDING ENHANCED JOB SEARCH CAPABILITY TO USERS”, Serial No.: 2999/DEL/2013, Filed: 8 Oct. 2013, which is incorporated in its entirety herewith.

### BACKGROUND OF THE DISCLOSURE

1. Technical Field

The present disclosure relates to software systems, and more specifically to facilitating users/job seekers to find suitable jobs using a job website.

2. Related Art

A job website facilitates job seekers to find suitable jobs from a set of currently available jobs. The job website may also facilitate employers to create job postings indicating such available jobs. The job postings thus received are facilitated to be browsed by job seekers to find desired/suitable jobs. Examples of such job websites include Monster™, Naukri™, Dice™, etc.

In one prior approach, a job website provides a search capability in the form of a search input interface containing multiple fields and/or options, with job seekers being required to specify text in the fields and select options, reflecting their interest. Job postings matching the provided inputs are then displayed to the job seekers.

It is generally desirable that job seekers be provided effective mechanisms for finding suitable jobs when interacting with job websites.

### BRIEF DESCRIPTION OF THE DRAWINGS

Example embodiments of the present disclosure will be described with reference to the accompanying drawings briefly described below.

FIG. 1 is a block diagram illustrating an example environment in which several aspects of the present disclosure can be implemented.

FIG. 2 is a flow chart illustrating the manner in which users are enabled to find suitable jobs using a job website according to an aspect of the present disclosure.

FIG. 3 depicts the manner in which the details of job postings are maintained in a job repository in one embodiment.

FIG. 4A illustrates the manner in which an input user interface/job universe is provided in one embodiment.

FIG. 4B illustrates the manner in which an input user interface/custom job universe specific to a job seeker is provided in one embodiment.

FIG. 4C illustrates the manner in which an input user interface/job universe is updated/adapted in one embodiment.

FIG. 5 illustrates other example viewports that can be provided as part of an input user interface in one embodiment.

FIG. 6 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Definitions

A. Job Posting: Content specifying various details of a job that is available for job seekers.

Job postings are commonly provided by the employers or agents of employers.

B. Dimension: A characteristic/attribute that would be of interest to job seekers when browsing for suitable jobs. Examples of dimensions include static information such as required qualification, minimum/maximum education level, job location, prior experience duration, etc., typically included in the job postings or computed information such as salary benchmarks, job relevance, employer rating, workability index, etc., based on which also job searches may be performed.

C. Dimensional value (referred to as “value” for conciseness): A value associated with a job posting corresponding to a dimension. Some of the values are specified in the job posting, some values inherently present (e.g., time of posting) by the event of job posting, and some may be computed.

D. Viewport: An area (typically rectangle) visually delineated on a display unit for the convenience of users (here job seekers). A display screen (displayed on the display unit) may be viewed as containing one or more view ports, depending on the number of such visual delineations.

E. Input User Interface: The user interface provided to a job seeker on a display unit of an end user system (used by the job seeker). The user interface contains multiple viewports, with each viewport displaying values of a corresponding dimension. The user interface also enables a user to select one more values in said viewports to cause the viewports to be updated based on the job postings matching the selection.

F. Job Universe: The jobs based on which the display of the input user interface is generated. The job universe can be the available job postings maintained in the repository, or can be a subset of the available job postings, based on user selections or profile, as described below with examples.

2. Overview

According to an aspect of the present disclosure, a repository of job postings organized with multiple dimensions is maintained, with each job posting being associated with values for one or more dimensions. A corresponding group of values for each of a set of dimensions are identified such that each value has at least one available job posting in the repository. A user interface definition is then sent to an end user system, the user interface definition when rendered on a display unit of the end user system provides an input user interface to a job seeker, the input user interface containing a set of viewports, each viewport corresponding to a dimension of the set of dimensions and showing the group of values for the dimension.

It may be appreciated that such a display of the various values of dimensions provides a user/job seeker with a state (the different types of jobs available, a comparison of different values for the same type, etc.) of the set of available jobs. Furthermore, by choosing the appropriate values for the dimensions (e.g., using adverbs and adjectives), the input user interface captures the “feel” of the available jobs.

According to another aspect of the present disclosure, a job seeker is enabled to select one or more values of the viewports of the displayed input user interface (noted above). In response to the selection, job postings matching the selected values are determined based on examining the repository, a new groups of values for each dimension is formed such that the values in each new group is associated with at least one of the matching job postings, and then the viewports of the input user interface are updated with the new group of values. In other words, the job universe/input user interface is “adapted” to reflect the selection of the job seeker.

It should be noted that the initial display of the job universe and thereafter adaptation of the job universe to the user selection facilitates users/job seekers to find suitable jobs in a more effective manner when interacting with job websites.

According to another aspect of the present disclosure, the job universe (and accordingly the input user interface) shown to a job seeker is filtered automatically (without the job seeker performing any action) based on a stored profile of the job seeker using matching skills, experience, location etc. Such filtration ensures that the “custom” job universe provided to the job seeker reflects the requirements of the job seeker, thereby enabling the job seeker to find a suitable job more effectively.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 3. Example Environment

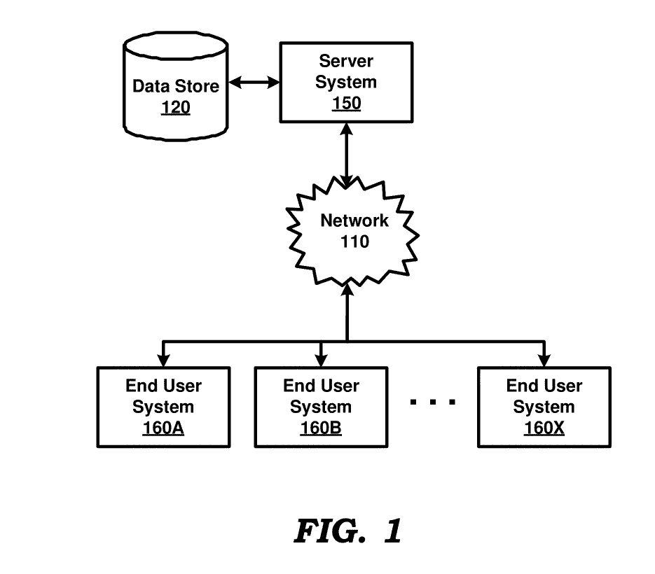

FIG. 1 is a block diagram illustrating an example environment in which several aspects of the present disclosure can be implemented. The block diagram is shown containing network 110, data store 120, server system 150, and end user systems 160A-160X.

Merely for illustration, only representative number/type of systems is shown in the Figure. Many environments often contain many more systems, both in number and type, depending on the purpose for which the environment is designed. Each system/device of FIG. 1 is described below in further detail.

Network 110 provides connectivity between server system 150, and end user systems 160A-160X, and may be implemented using protocols such as Transmission Control Protocol (TCP) and/or Internet Protocol (IP), well known in the relevant arts. In general, in TCP/IP environments, an IP packet is used as a basic unit of transport, with the source address being set to the IP address assigned to the source system from which the packet originates and the destination address set to the IP address of the destination system to which the packet is to be eventually delivered.

A (IP) packet is said to be directed to a destination system when the destination IP address of the packet is set to the (IP) address of the destination system, such that the packet is eventually delivered to the destination system by network 110. When the packet contains content such as port numbers, which specifies the destination application, the packet may be said to be directed to such application as well. The destination system may be required to keep the corresponding port numbers available/open, and process the packets with the corresponding destination ports. Network 110 may be implemented using any combination of wire-based or wireless mediums.

Data store 120 represents a non-volatile (persistent) storage facilitating storage and retrieval of data (such as the details of the job postings, the dimensions according to which the job postings are classified, the details of the candidates, etc.) by applications executing in server system 150. Data store 120 may be implemented as a corresponding database server using relational database technologies and accordingly provide storage and retrieval of data using structured queries such as SQL (Structured Query Language). Alternatively, data store 120 may be implemented as a corresponding file server providing storage and retrieval of data in the form of files organized as one or more directories, as is well known in the relevant arts. Typically, the job data is stored as a combination of both relational/non-relational databases and file systems.

Each of end user systems 160A-160X represents a system such as a personal computer, workstation, mobile station, mobile phones, computing tablets, etc., used by users (e.g. job seekers) to generate user requests directed to applications executing in server system 150. The user requests may be generated using appropriate user interfaces (for example, web pages provided by applications executing in server system 150). In general, a user using a end user system (such as 160A) sends user requests to server system 150 for performing desired tasks, and receives corresponding responses containing the results of performing the desired tasks.

Server system 150 represents a server, such as a web/application server, executing applications capable of processing user requests received from users using one of end user systems 160A-160X. Server system 150 may use data stored internally (for example, in a non-volatile storage/hard disk within the system), external data (for example, stored in data stores such as 120) and/or data received from external sources (e.g., from the user) in processing of the user requests. The server system then sends the result of processing of the user requests to the requesting end user system (one of 160A-160X).

In one embodiment, server system 150 hosts a job website (application) that maintains job postings in a job repository (for example, in data store 120). The job website also facilitates users/job seekers using one of end user systems 160A-160X to find suitable jobs by browsing the job postings stored in the job repository.

As noted in the Background Section, the job website may provide a search capability to the job seekers. The job website may accordingly provide a search input interface (web page) to the users, receive text and selected options reflecting the interest of the users as inputs, and then provide a listing of the job postings matching the received inputs.

It may be appreciated that such an approach requires the job seeker to have a great degree of clarity in the kind of job he/she is searching for, be aware of (and/or familiar with) the specific keywords/texts used by the job website, and to iteratively alter the search inputs using different keywords and options until the job postings of interest are included in the search result list. In addition, in the scenario that a job seeker has multiple interests, finding job listings of interest using a text based search can be a time consuming and frustrating experience. Furthermore, when the job repository does not have any job postings matching the interest/inputs of the job seeker, the job seeker/user may realize the absence only after multiple search attempts have failed to return any job postings of interest.

Server system 150, implemented according to several aspects of the present disclosure, facilitates users to find suitable jobs more effectively when interacting with job sites as described below with examples.

### 4. Finding Suitable Jobs Using a Job Website

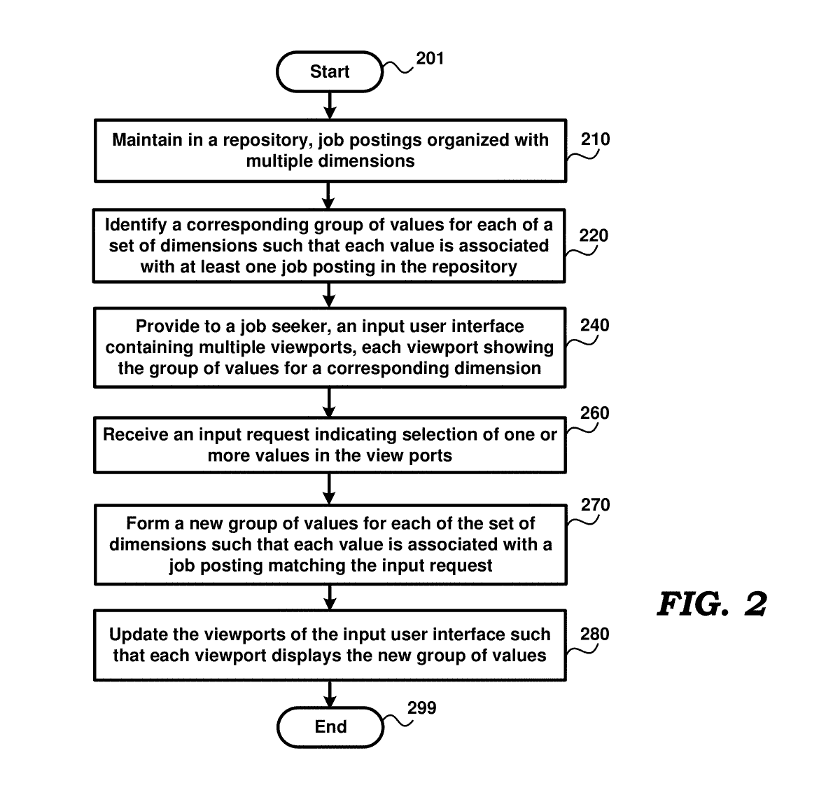

FIG. 2 is a flow chart illustrating the manner in which users are enabled to find suitable jobs using a job website according to an aspect of the present disclosure. The flowchart is described with respect to the systems of FIG. 1, in particular server system 150, merely for illustration. However, the features can be implemented in other systems and environments also without departing from the scope and spirit of various aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. The flow chart begins in step 201, in which control immediately passes to step 210.

In step 210, server system 150 maintains job postings in a repository (such as data store 120) organized with multiple dimensions, with each job posting normally having one value (but none or multiple, being a possibility in corresponding embodiments) for a dimension. Examples of dimensions are job type, education level, employer name, time of posting, salary, salary benchmark, workability index etc. Many dimensions are part of the base job data, while certain dimensions (e.g. Salary Benchmarks) are computed from other dimensions as described in below sections.

In step 220, server system 150 identifies a corresponding group of values for each of a set of dimensions such that each value is associated with at least one available job posting in the repository. In other worlds, a value is included in the group if there is at least one available job posting in the repository having that value for the dimension. The group of values for a dimension accordingly represents the attribute instances in relation to available job postings for the dimension. The number of values that are to be included in the group for a dimension can be limited to “Top X” or “Recent X” or “Most Active X”, where X represents a corresponding number.

The identification of the values may be performed at any convenient time instance. For example, the groups of values corresponding to different dimensions may be maintained in a memory and thereafter updated in response to any change (add, delete, update) to the job postings in the repository. Alternatively, the identification may be performed in response to receiving (using one of end user systems 160A-160X) an indication of interest from a user/job seeker to view the jobs in the repository.

In step 240, server system 150 provides to a job seeker, an input user interface containing multiple viewports, each viewport showing the group of values for a corresponding dimension (of the identified set of dimensions). The input user interface may be provided in response to a user/job seeker sending an indication of interest for searching for jobs (noted above) from one of end user systems 160A-160X. In one embodiment, a user interface (e.g. web page) definition is sent to the requesting end user system (assumed to be 160A, for illustration), the user interface definition when rendered on a display unit of end user system 160A provides the input user interface.

As noted above, each viewport is in the form of an area (typically rectangle or a polygon in general) visually delineated on the display unit for the convenience of job seekers, with the input user interface containing one or more such view ports, depending on the number of such visual delineations. The display of the multiple viewports as part of a single user interface presents the existing job universe to the user/job seeker.

In step 260, server system 150 receives an input request (from end user system 160A) indicating selection of one or more values in the view ports. The request may be specified by the user using a keyboard and/or pointing device such as a mouse or fingers in case of a touch enabled interface like a tablet. For example, the values of each dimension may be provided as hyperlinks (according to HTML) and a user/candidate may click/select/touch the desired hyperlinks using the pointing device/finger to indicate the selection of the corresponding values.

In step 270, server system 150 forms a new group of values for each of the set of dimensions such that each value is associated with a job posting matching the input request. Thus, in response to the input request, server system 150 first determines (by examining the repository) the subset of job postings in the repository that matches the received selection of values. Server system 150 thereafter forms the new group of values for each dimension based on the determined subset of job postings.

In step 280, server system 150 updates the viewports of the input user interface (displaying on the display unit of end user system 160A) such that each viewport displays the new group of values. Thus, the initial job universe (shown in step 240) is adapted according to selection of the user/job seeker. The flow chart ends in step 299.

By providing an insight/overview into the state of all the job postings (“job universe”) currently available in the job repository, and thereafter adapting the job universe based on user selections, a user/job seeker facilitated to find job postings of interests (and accordingly shortlist suitable jobs) rapidly. The manner in which server system 150 enables job seeker to find suitable jobs using a job website according to the steps of FIG. 2 is illustrated below with examples.

### 5. Illustrative Example

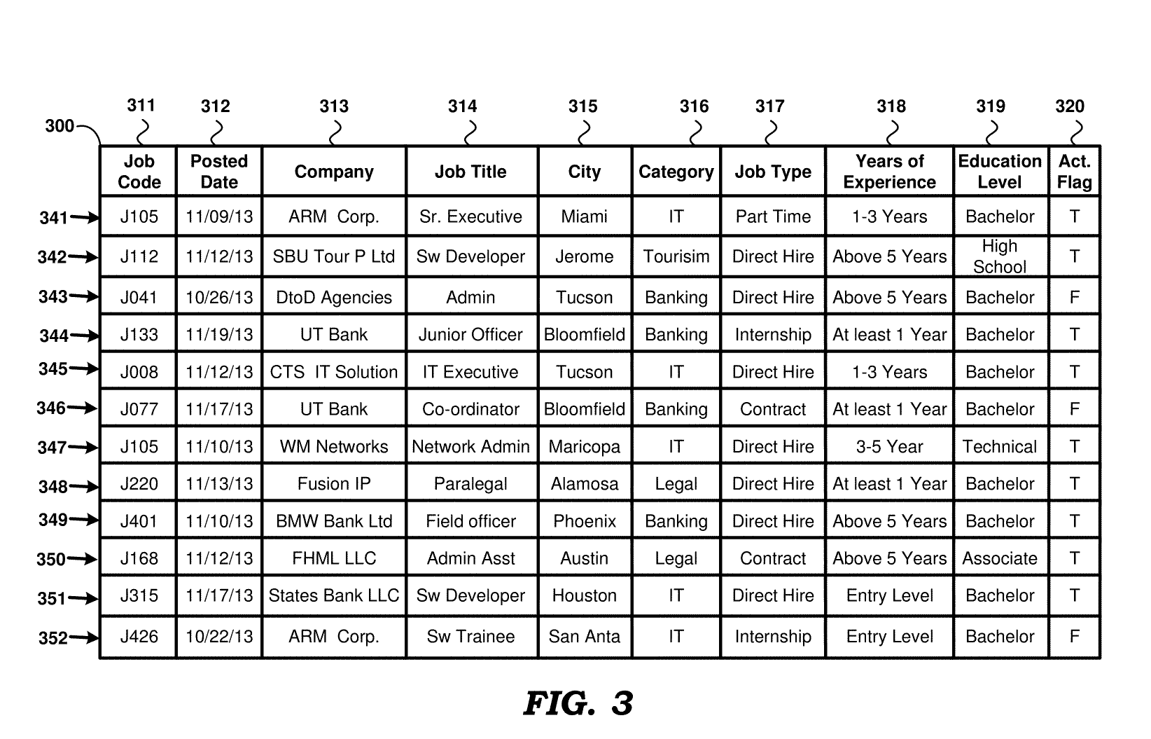

FIGS. 3, 4A-4C and 5 together illustrate the manner in which a search capability is provided in a job website in one embodiment. Each of the Figures is described in detail below.

FIG. 3 depicts the manner in which the details of job postings are maintained in a job repository in one embodiment. For illustration, it is assumed that data store 120 is implemented as a database server and accordingly the job repository is maintained in the form of a table (300) in a database in the database server. However, in alternative embodiments, the repository may be maintained in any other format such as XML (Extensible Markup Language), text files, etc. and/or in other data store such as a file server as will be apparent to one skilled in the relevant arts by reading the disclosure herein.

Table 300 depicts a portion of job postings maintained in a database in data store 120. Column 311 (“Code”) specifies a unique job code for each job posting. The unique job code may be generated by the job website (application) in response to a user (e.g., an employer or an agent of the employer) creating a new job posting using appropriate user interfaces (not shown here). Column 312 (“Posted Date”) indicates the date of creation of each job posting (typically filled in by the application), while column 313 (“Company”) indicates the name of the employer for each job posting (entered by the agent/employer).

Column 320 (“Act. Flag”) specifies an active flag which indicates whether the corresponding job posting is active (value “T”) or not (value “F”). A job posting is indicated to be active if job posting is to be included in the job universe displayed to job seekers. Thus, the job universe displayed to users/job seekers includes only the active job postings. A job posting may be marked as not active (such as the job postings of rows 343, 346 and 352) for reasons such as the job posting is old (e.g., posted date is before 6 months), the job posting has already been filled and as such no longer required, the employer has manually deactivated the job posting, etc.

Each of columns 314 (“Job Title”), 315 (“City”), 316 (“Category”), 317 (“Job Type”), 318 (“Years of Experience”) and 319 (“Education Level”) represents a corresponding dimension/attribute type along which the job postings are organized in the job repository. The value specified in a corresponding column (e.g. 316) represents the value/attribute instance for the job posting for the corresponding dimension (e.g., “Category”). Though only a single value is shown specified for each dimension (for a job posting), it may be appreciated that each job posting may be associated with no value for a dimension (which may be implemented by storing a pre-defined value such as NULL as the value) or multiple values for a dimension (which may be implemented by storing the values, for example, as a comma separated list).

It should be noted that only a few columns/dimensions are shown here for illustration. However in alternative embodiments, other additional information related to the job posting (non-dimensional data) such as the date and time of job posting (column 312), the specific user who created the posting, salary, etc. may also be stored (for example, as additional columns, not described here). In addition, computed dimensions such as salary benchmark, job relevance, feedback rating, social index, employer rating, workability index dimension, etc. (the computation of which is described in detail in the below sections) may also be stored in corresponding columns (not shown here).

Each of rows 341-352 specifies the details of a corresponding job posting in the job repository. For example, row 341 specifies a job posting having the job code “J105” which was posted on Nov. 9, 2013 for the employer named “ARM Corp.” The job posting further indicates the value “Sr. Executive” for the dimension “Job Title”, the value “Miami” for the dimension “City”, the value “IT” for the dimension “Category”, the value “Part Time” for the dimension “Job Type”, the value “1-3 years” for the dimension “Years of Experience” and the value “Bachelor” for the dimension “Education Level”. Similarly the other rows 342-352 respectively specify the details of other job postings in the job repository.

Thus, the details of the job postings organized with multiple dimensions are maintained in a job repository (table 300). It should be appreciated that only a sample number of job postings and its dimensions are shown in table 300 for illustration. However, in general, the job repository may maintain a large number of job postings (in the range of 1000-10000+) that are organized with a different/larger number of dimensions, as will be apparent to one skilled in the relevant arts by reading the disclosure herein.

The manner in which an input user interface/job universe reflecting the available job postings in a job repository (portions of which are shown in table 300) may be provided to users/job seekers is described below with examples.

### 6. Job Universe

The job universe can initially include all of the set of active/available job postings in the job repository. It should be noted the job universe is provided upfront without any search attempt by the user/job seeker. The job universe depicts the “state” and also the “feel” of the jobs currently available in the form of various dimensions. Such a feature facilitates the job seekers to determine very quickly whether there are any job postings of interest in the repository without having to spend time in searching.

Accordingly, server system 150 inspects the job repository (300) to identify the set of unique values in each column of table 300 as forming the group of values for the corresponding dimension. For example, the set of unique values (including “IT”, “Banking”, “Legal”, “Tourism” shown in FIG. 3) in the column 316 of table 300 is identified as the corresponding group of values for the dimension “Category”. Similarly, server system 150 may identify the group of values for each dimension (e.g. “Job Type”, “City”, etc.) by inspecting the corresponding columns. It should be noted that the determination of the set of unique values in each column ensures that each value in the group is associated with at least one (or in general, multiple) job postings.

Server system 150 may thereafter provide an input user interface/job universe containing multiple viewports, each viewport corresponding to a dimension and showing the group of values for the dimension. The description is continued assuming that the input user interface is shown in response to receiving an indication of interest from a user/job seeker to view/browse the available job postings in the repository. The indication of interest is assumed to be received from end user system 160A (though such an indication may be sent from other end user systems as well). For example, the user/job seeker may enter a specific search URL (Uniform Resource Locator) in the address bar of a browser executing in end user system 160A. Alternatively, the user may click a hyperlink provided in a web page (currently being displayed in the browser) to send the indication.

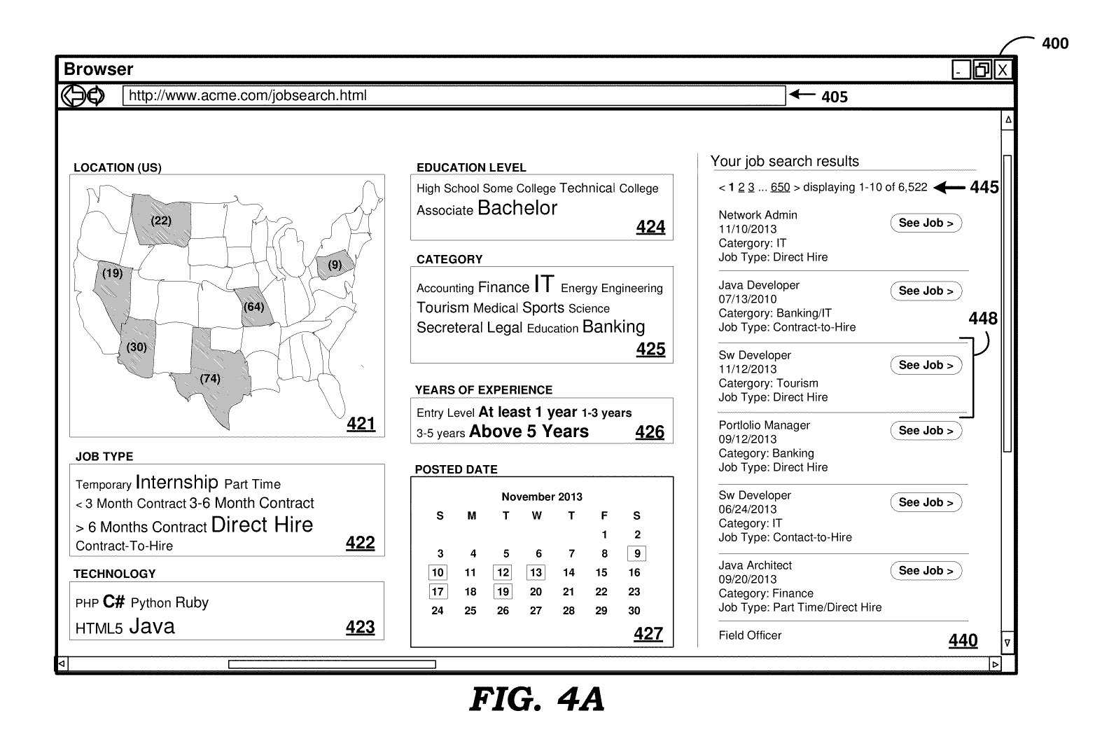

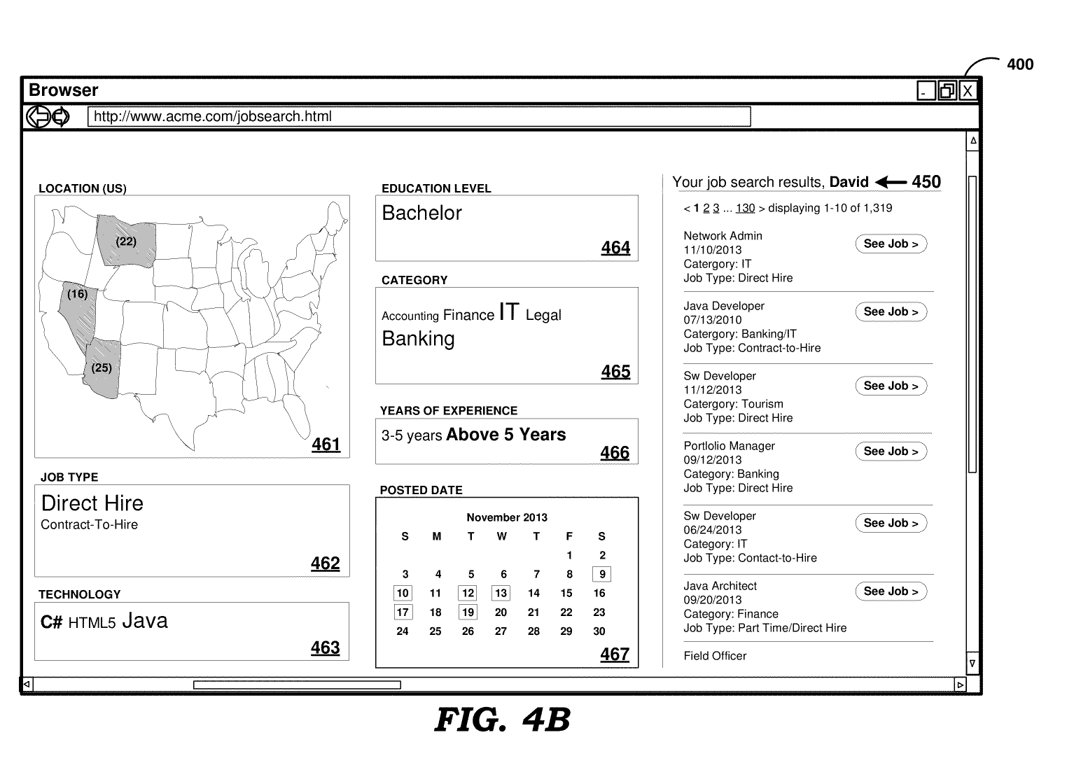

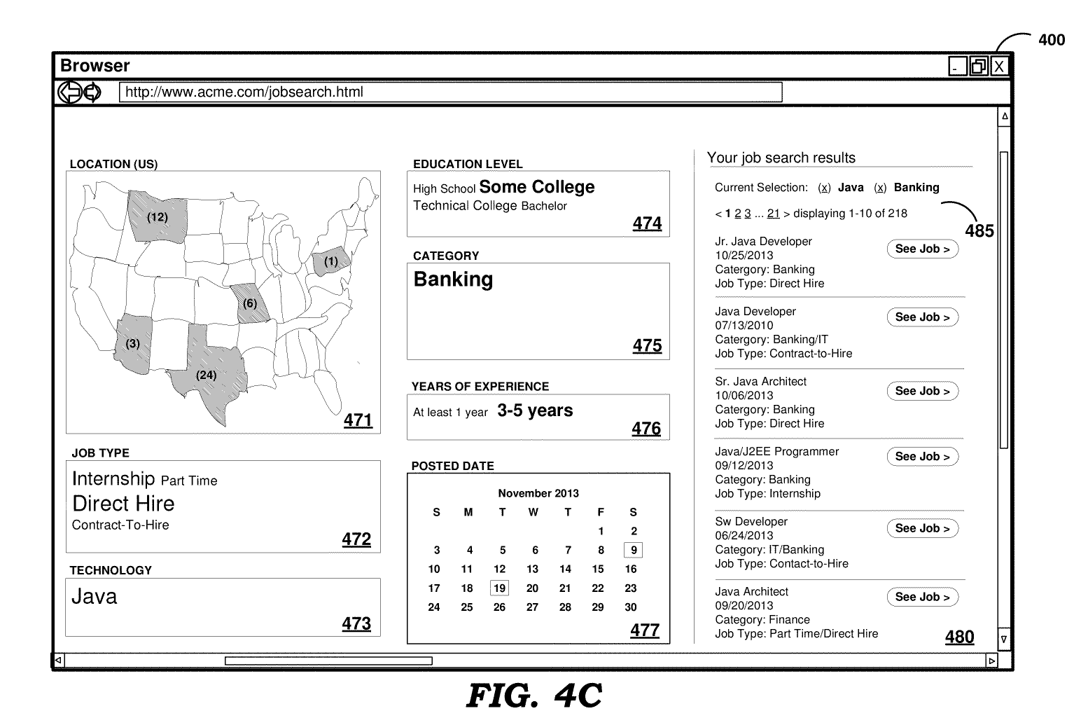

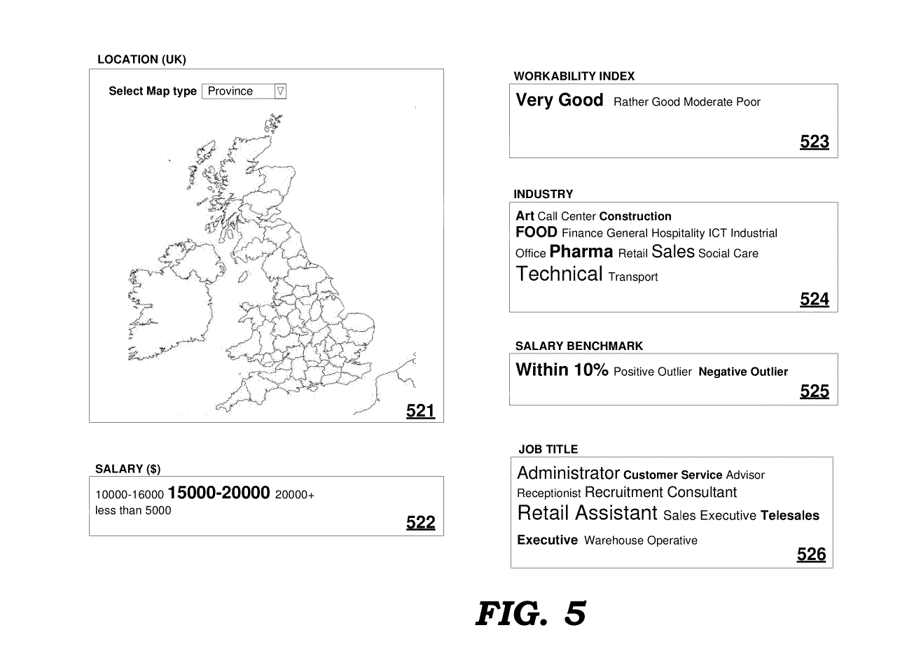

FIG. 4A illustrates the manner in which an input user interface/job universe is provided in one embodiment. Display area 400 of FIGS. 4A-4C (and also the viewports of FIG. 5) depicts a corresponding portion of a user interface provided on a display unit (not shown in FIG. 1) associated with end user system 160A (or other end user systems). In one embodiment, display area 400 corresponds to a webpage accessed by the users using a browser in response to sending a request (including the search URL as indicated by the text in display area 405) from end user system 160A to server system 150. Each web page is received from server system 150 prior to being displayed (using the browser) on the display unit.

Each of display areas 421-427 represents a corresponding viewport provided to the user/job seeker. It may be observed that each of display areas 421-427 is a rectangular area that is visually delineated (by the corresponding rectangle) on a display unit for the convenience of users/job seekers. The name of the dimension (e.g. “EDUCATION LEVEL” is shown on top of the corresponding rectangular display area (e.g. 424). It may be observed that each display area/viewport 421-427 is shown displaying a corresponding group of values based on the job postings present in the job repository.

Viewport 421 is shown displaying a map of the locations (in the United States of America) where job postings are currently available. In particular, states that are associated with at least one job posting are shown filled/highlighted with gray, with the actual number of job postings (e.g., 22, 19, etc.) indicated in brackets within the boundary of the corresponding state. It may be appreciated that server system 150 may determine the state corresponding to each job posting based on the values in the City column 314 of table 300.

Each of viewports 422-426 is shown displaying the corresponding group of values in the form of a corresponding tag cloud. As is well known, in a tag cloud, the values/tags are displayed as labels of varying font sizes (and/or possibly different fonts/colors), with the relative difference in font size/font/color of the values indicating the corresponding relative difference in the number of job postings associated with that specific value for the dimension. For example, in viewport 425 for the “Category” dimension, the display of “Banking” value in a larger/prominent font size (in comparison to the other values) indicates that the maximum number of job postings is associated with the value “Banking” for the “Category” dimension.

Viewport 427 (for the dimension “POSTED DATE”) is shown displaying a calendar, with the dates having associated job postings highlighted (using squares). Such as calendar may be displayed based on the values in “Posted Date” column 312 of table 300.

Though only a few representative viewports are described herein, it may be appreciated that the values of each dimension may be presented in any convenient format, as suited to the specific environment, in the corresponding viewport. In general, if a first value of a dimension that is associated with more number of job postings in the repository than a second value of the same dimension, the first value is displayed (in a viewport) with a higher prominence in comparison to the display (in the same viewport) of the second value. Such higher prominence may be affected by using a combination of one or more of change in font (bigger vs smaller type face, higher vs smaller font height, etc.), color (darker vs lighter shade, different colors), etc.

It may be observed that a set of job postings currently present in the job repository is shown in display area 440, with display area 445 indicating the total number (6522) of job postings currently present. Display area 448 provides the details of a single job posting (here corresponding to the data maintained in row 342 of table 300), with the “See Job >” button enabling the user to view more (or all of) the details related to the specific job posting (of 448). It should be noted that in alternative embodiments, such a listing of job postings may be absent from the input user interface, and instead may be provided only upon the user/job seeker submitting a search request.

It may be appreciated that there may occur a scenario where the job repository contains at least one job posting associated with a specific value (e.g., “Entry Level”) for a dimension (e.g., “YEARS OF EXPERIENCE”) at a first time instance, but contains no job postings associated with the specific value at a second time instance following the first time instance. For example, the specific value may be associated with a single job posting in the job repository at the first time instance, and the single job posting may be deleted or deactivated (active flag=“F”) at the second time instance causing the specific value to be associated with no job postings. In such a scenario, the specific value is present in the group of values for the dimension displayed in a viewport (426) between the first time instance and the second time instance, but is absent in the group of values for the dimension displayed in the viewport after the second time instance.

Thus, an input user interface/job universe reflecting a current state of the job postings available in the repository is provided to users/job seekers. It may be appreciated that the job universe of FIG. 4A is presented to any user/job seeker wishing to view the available job postings. However, in some situations, it may be desirable that the job universe be customized to each user/job seeker. The manner in which such a custom job universe may be presented to a user/job seeker is described below with examples.

### 7. Custom Job Universe

According to an aspect of the present disclosure, the job universe (and accordingly the input user interface) shown to a job seeker is filtered automatically (without the job seeker performing any action) based on a stored profile of the job seeker using matching skills, experience, location etc. Such filtration ensures that the “custom” job universe provided to the job seeker reflects the requirements of the job seeker, thereby enabling the job seeker to find a suitable job more effectively.

FIG. 4B illustrates the manner in which an input user interface/custom job universe specific to a job seeker is provided in one embodiment. The user interface is similar to that of FIG. 4A, and accordingly the description of similar elements is not repeated here again for conciseness.

Display area 450 indicates that the input user interface is provided for the job seeker named “David”, whose profile indicates that he has a bachelor's degree, is currently located at San Diego, knows the technologies C#, Java and HTML5, etc. Accordingly, server system 150 determines the “custom” job universe for the job seeker David to include only those job postings that match the profile of the job seeker. Server system 150 then determines the corresponding groups of values for each dimension based on the custom job universe for the job seeker.

Accordingly, viewports 461-467, though similar to viewports 421-427, are show displaying only some of the values that are associated with at least one job posting in the custom job universe. In particular, viewport 461 is shown displaying the job postings available on the west coast of the United States of America, in view of the user currently being located in a west coast city. Furthermore, viewports 463 and 464 respectively indicates that only the job postings that are related to the technologies and education level of the job seeker (David) is currently included in the job universe.

It may be appreciated that the input user interface of FIGS. 4A/4B forms the basis for providing users/job seekers visiting the job website to find suitable jobs more effectively. An aspect of the present disclosure enables the users/job seekers (or the specific job seeker such as “David”) to adapt the job universe by selecting one or more values in the displayed viewports (such as 421-427 or 461-467).

The description is continued illustrating the manner in which an adapted job universe is provided with respect to the input user interface of FIG. 4A, though a similar capability can also be provided with respect to the input user interface of FIG. 4B as will be apparent to one skilled in the relevant arts by reading the disclosure herein.

### 8. Adapting the Job Universe

In response to viewing the input user interface of FIG. 4A, a user/job seeker may indicate a selection of one or more values in different view ports (421-427). For example, the user may select a desired US state in viewport 421, one or more values in viewports 422-426 and a posted date in viewport 427. The specific manner in which a user may indicate the selection (and is thereafter displayed to the user) can be implemented consistent with the environment (e.g. desktop, tablet, mobile) of the end user system. For example, in a touch enabled device, a user may indicate selection by touching (with his/her finger) the desired values on the display unit. Each selected value may then be highlighted in a different color to indicate to the user the current selection.

The description is continued assuming that the user has selected the value “Banking” in the “Category” dimension and the value “Java” in the “Technology” to thereby cause an input request to be sent (from end user system 140A) to server system 150 with the value “Banking” for the “Category” dimension and the value “Java” for the “Technology” dimension. It may be appreciated that the sending of the input request may be implemented in any convenient manner For example, the input request may be sent at regular intervals based on the selections made in a previous interval, or may be sent in response to a user clicking on a send button (not shown in the Figure).

In response to an input request, server system 150 examines the job repository (table 300) to determine the job postings matching the values specified in the input request. For the above noted input request, server system 150 determines the matching job postings that have the value “Banking” for the “Category” dimension and the value “Java” for the “Technology” dimension. Server system 150 then forms a new group of values for each dimension (corresponding to viewports 421-427) such that each value in the new group is associated with at least one of the matching job posting. Server system 150 then updates the viewports (421-427) of the input user interface with the new group of values as described in detail below.

FIG. 4C illustrates the manner in which an input user interface/job universe is updated/adapted in one embodiment. Each of viewports 471-477 respectively corresponds to viewports 421-427 of FIG. 4A, but with the values for each dimension updated based only on the matching job postings (instead of all the active job postings as in FIG. 4A). For example, in viewport 471, the number of job postings in each state is shown updated to reflect the number of job postings in the matching set (determined for the input request). In viewport 472, some the values such as “Temporary” and “<3 Month Contract” (shown in viewport 422) are not shown due to no job posting in the matching set being associated with such values.

Furthermore, display area 480 provides a list of job postings that match the input request specified by the user, that is, “Banking” for the “Category” dimension and the value “Java” for the “Technology” (as also indicated by display area 485). Display area 485 also indicates the number of matching job postings (218) found for the input request in the job repository.

Thus, a user/job seeker is provided an “adapted” job universe. It should be appreciated that the user may iteratively perform the selection of one or more values (for example, in viewports 471-477) and view the resulting adapted job universes. Alternatively, the user interface of FIGS. 4A-4C may be enabled to provide the “adapted” job universe in response to each selection by a user/job seeker. In general, the various viewports may be viewed as being connected with each other such that any action (selection of a value) in one viewport causes the other viewports to automatically adjust and adapt, thereby enabling the job seekers to more effectively find suitable jobs on a job website.

In addition, the automatic filtering of the job universe based on job seeker's stored profile and the extraction of the job postings by combining the job profile with external information like past feedback, employer information, etc. further enhances the quality of the initial job universe displayed to the users/job seekers. In general, server system 150 provides various dimensions/viewports that capture the state and “feel” of the available jobs in the repository. Some additional dimensions/viewports that may be provided to users/job seekers is described below with examples.

### 9. Other Dimensions/Viewports

FIG. 5 illustrates other example viewports that can be provided as part of an input user interface in one embodiment. Each of viewports 521-526 represents a corresponding viewport that may be provided as part of the input user interface of FIG. 4A (or 4B). Viewport 521 provides an interactive map that enables the job seeker to view the job postings by country, state/province, district, city, etc. (by selecting the appropriate option in the “Select Map type” drop down list). Such a drilling down may be performed at any desired geographical location, and also causes the other viewports to be updated based on the map type chosen by the user/job seeker.

View ports 522-526 depict tag clouds for other dimensions such as salary, workability index, industry, salary benchmark, job title (based on column 314 of table 300), etc. Though not shown, other dimensions (and corresponding viewports) may include feedback and ratings of employer, number of open positions, employer name, etc. It may be appreciated that most of the dimensions shown herein (such as salary and job title) contains value that are entered by different employers while adding the respective job postings to the repository.

However, some of the dimensions such as workability index (523) and salary benchmark (525) and the corresponding group of values are computed by server system 150. In general for a computed dimension, server system 150 inspects the available job postings in the repository to identify a set of buckets, and then classifies each of the available job postings into one (or more, in alternative embodiments) of the identified buckets. The group of values for each computed dimension is formed form the labels/names of the set of buckets identified for the dimension. Examples of computed dimensions are salary benchmark (523), job relevance, feedback rating, social index, employer rating and workability index (525).

Salary benchmark compares the salary of each job porting against the typical salary offered for that role in the industry, in a specific geographic location. The typical salary offered may be computed based on the values entered by employers in the salary dimension (522). In one embodiment, the salary benchmark is measured at a specific percentile such as 75th percentile, with the buckets being “Within 10%” of 75th percentile, “Positive Outlier” (Salary>10% of the typical 75th percentile), “Negative Outlier” (Salary<10% of the typical 75th percentile). It may be observed that the labels of the buckets are shown as corresponding values of the salary benchmark dimension in viewport 525, with the corresponding prominence of each bucket/value being based on the number of job postings classified into each bucket.

Job relevance provides an indication of how relevant a job posting is to the job seeker (for example, based on the profile of the job seeker). In one embodiment, relevance may specified as a percentage of the match between the job posting and the profile, with the buckets being 100%, 90%, 80% etc. The job relevance may be computed based on the details of the job posting and the profile of the job seeker.

Feedback rating for an employer may be computed based on the rating provided to the employer by the past job seekers and/or employees. In one embodiment, the rating is specified as a number between 1 and 5 (or corresponding stars, as is well known). The feedback rating may be computed by analyzing the comments received (from job seekers and employees) for each employer.

Social index indicates a rating of the social media presence of each employer. The social index may be computed based on various factors such as the number of “likes” received, the number of fans, favorable comments, articles, fresh content etc. related to the employer. In one embodiment, the social index is computed as a score between 1 and 100, with a higher score for an employer indicating that the employer is more socially connected and/or networked. The social index may be computed based on the social media activity performed by the different employers.

Employer rating indicates a rating of the employer based on various factors like financial stability, the number of current employees, the number of past placements, feedback rating (noted above), social index (noted above), etc. In one embodiment, the employer rating contains buckets such as A+, A, B+, B, C+, C, etc. with each job posting being classified into one of these buckets.

Workability index is a culmination of all the dimensions and ratings into a single value which indicates how good each job posting is (in comparison to the other job postings). As such, workability index is a computed dimension based on other computed dimensions like salary benchmark, feedback rating, social index, employer rating and other dimensions like geographic location (living standards, crime rate, tax rate etc.), job type (permanent, temporary etc.) etc. Each of the values may be provided a corresponding configurable weight and the working index may be computed based on the weights and values of the dimensions. In one embodiment, the buckets/values for the workability index are “Excellent”, “Very Good”, “Good”, “Poor”, and “Fair”.

It should be appreciated that the features described above can be implemented in various embodiments as a desired combination of one or more of hardware, executable modules, and firmware. The description is continued with respect to an embodiment in which various features are operative when executable modules are executed.

### 10. Digital Processing System

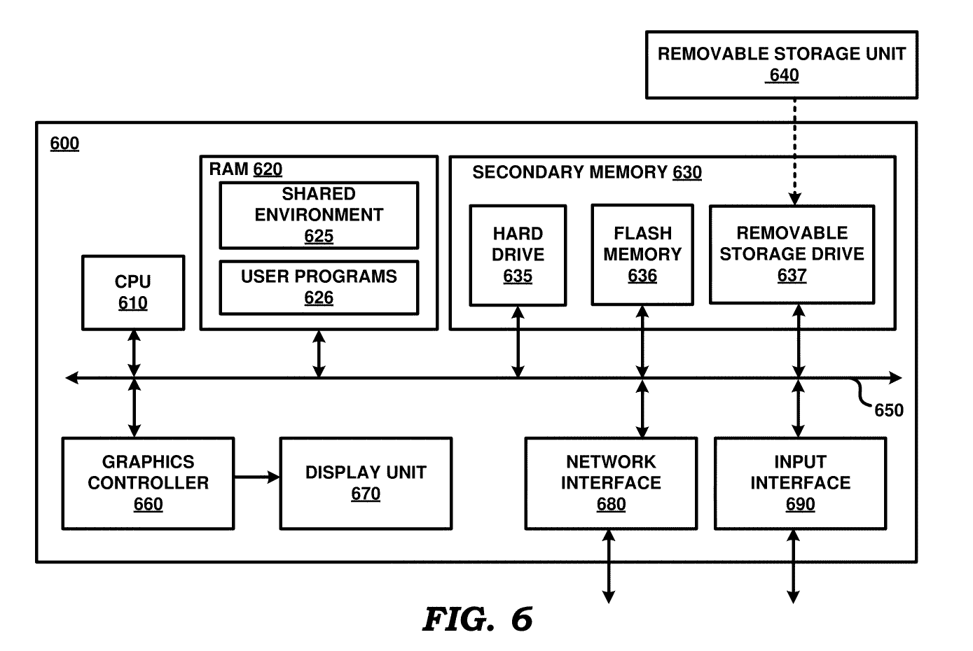

FIG. 6 is a block diagram illustrating the details of digital processing system 600 in which various aspects of the present disclosure are operative by execution of appropriate executable modules. Digital processing system 600 may correspond to each of server system 150 and end user systems 160A-160X.

Digital processing system 600 may contain one or more processors such as a central processing unit (CPU) 610, random access memory (RAM) 620, secondary memory 630, graphics controller 660, display unit 670, network interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present disclosure. CPU 610 may contain multiple processing units, with each processing unit potentially being designed for a specific task. Alternatively, CPU 610 may contain only a single general-purpose processing unit.

RAM 620 may receive instructions from secondary memory 630 using communication path 650. RAM 620 is shown currently containing software instructions constituting shared environment 625 and/or other user programs 626 (such as other applications, DBMS, etc.). In addition to shared environment 625, RAM 620 may contain other software programs such as device drivers, virtual machines, etc., which provide a (common) run time environment for execution of other/user programs.

Graphics controller 660 generates display signals (e.g., in RGB format) to display unit 670 based on data/instructions received from CPU 610. Display unit 670 contains a display screen to display the images defined by the display signals. Each of the displays shown in FIGS. 4A, 4B and 4 corresponds to an image screen displayed at corresponding time duration on the display screen. Input interface 690 may correspond to a keyboard and a pointing device (e.g., touch-pad, mouse) and may be used to provide inputs (such as those provided by users/job seekers using the user interfaces of FIGS. 4A, 4B and 5). Network interface 680 provides connectivity to a network (e.g., using Internet Protocol), and may be used to communicate with other systems (of FIG. 1) connected to the network (110).

Secondary memory 630 may contain hard drive 635, flash memory 636, and removable storage drive 637. Secondary memory 630 may store the data (for example, data of FIG. 3, the group of values identified for each dimension, etc.) and software instructions (for example, for implementing the flowchart of FIG. 2, computing the values of the dimensions, etc.), which enable digital processing system 600 to provide several features in accordance with the present disclosure. The code/instructions stored in secondary memory 630 may either be copied to RAM 620 prior to execution by CPU 610 for higher execution speeds, or may be directly executed by CPU 610.

Some or all of the data and instructions may be provided on removable storage unit 640, and the data and instructions may be read and provided by removable storage drive 637 to CPU 610. Removable storage unit 640 may be implemented using medium and storage format compatible with removable storage drive 637 such that removable storage drive 637 can read the data and instructions. Thus, removable storage unit 640 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 630. Volatile media includes dynamic memory, such as RAM 620. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 650. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 11. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method of enabling job seekers to find suitable jobs, said method comprising:
maintaining in a repository, a plurality of job postings organized with a plurality of dimensions, with each job posting being associated with respective values for one or more dimensions of said plurality of dimensions;
identifying a corresponding group of values for each of a set of dimensions such that each value of the group of values is associated with at least one available job posting in said repository, wherein said set of dimensions is contained in said plurality of dimensions; and
sending a user interface definition to a end user system, said user interface definition when rendered on a display unit of said end user system provides an input user interface to a job seeker, said input user interface containing a set of viewports, each viewport being associated with a dimension of said set of dimensions and showing the group of values identified for the associated dimension.

2. The method of claim 1, further comprising:
receiving an input request indicating selection of one or more values in said set of viewports;
determining a set of job postings matching said selection based on examining said repository, wherein said set of job postings is contained in said plurality of job postings;
forming, in response to said input request, a corresponding second group of values for each of said set of dimensions based on said set of job postings; and
updating said set of viewports on said display unit such that each viewport displays the corresponding second group of values for the associated dimension.

3. The method of claim 1, wherein at a first time instance, said repository contains at least one job posting associated with a first value for a first dimension of said plurality of dimensions but contains no job postings associated with said first value for said first dimension starting at a second time instance following said first time instance,
wherein said first value is present in the corresponding group of values for said first dimension displayed in a first viewport between said first time instance and said second time instance,
wherein said first value is absent in the corresponding group of values for said first dimension displayed in said first viewport after said second time instance.

4. The method of claim 3, wherein for a second dimension of said plurality of dimensions, the corresponding group of values contains only those values which are entered by different employers while adding said plurality of job postings to said repository, said method further comprising:
for each of a third set of dimensions of said plurality of dimensions, inspecting said plurality of job postings to identify a plurality of buckets, each of said plurality of job postings being classified into one so of said plurality of buckets for the corresponding dimension of said third set of dimensions,
wherein the group of values for each dimension of said third set of dimensions comprises the labels of said plurality of buckets identified for the dimension.

5. The method of claim 4, wherein said third set of dimensions includes a salary benchmark dimension, a job relevance dimension, a feedback rating dimension, a social index dimension, an employer rating dimension and a workability index dimension.

6. The method of claim 3, wherein said first dimension represents a location dimension, wherein said first group of values comprises a set of the locations associated with said plurality of job postings,
wherein said first viewport is provided in the form of a geographical map with each of said set of locations being highlighted in said geographical map,
wherein a count of the number of job postings associated with each of said set of locations is also displayed in said geographical map.

7. The method of claim 3, wherein said first group of values includes a second value and a third value, wherein the number of job postings associated with said second value in said repository is greater than the number of job postings associated with said third value in said repository,
wherein said second value is displayed with a higher prominence in comparison to the display of said third value in said first viewport.

8. The method of claim 7, wherein said higher prominence for said second value is obtained by using a combination of one or more of change in font and color.

9. The method of claim 3, wherein said first dimension represents a text dimension, wherein said first group of values comprises a set of texts associated with said plurality of job postings,
wherein said first viewport is provided in the form of a tag cloud with each of said set of text strings being displayed in a corresponding font height in said tag cloud,
wherein the font height of a text string is determined based on the number of job postings associated with said text string in said repository.

10. The method of claim 3, wherein said first dimension represents a date dimension, wherein said first group of values comprises a set of dates associated with said plurality of job postings,
wherein said first viewport is provided in the form of a calendar with each of said set of dates being highlighted in said calendar.

11. The method of claim 1, further comprising:
storing a profile of said job seeker; and
determining a subset of said plurality of job postings based on said profile of said job seeker,
wherein said identifying identifies said corresponding group of values for each of said set of dimensions such that each value is associated with at least one available job posting in said subset of said plurality of job postings.

12. The method of claim 11, further comprising:
receiving, from said end user system, an indication of interest from said job seeker to view the job postings present in said job repository,
wherein said determining, and said identifying and said sending is performed in response to receiving said indication of interest.

13. A non-transitory machine readable medium storing one or more sequences of instructions for causing a system to enable job seekers to find suitable jobs, wherein execution of said one or more instructions by one or more processors contained in said system causes said system to perform the actions of:
maintaining in a repository, a plurality of job postings organized with a plurality of dimensions, with each job posting being associated with respective values for one or more dimensions of said plurality of dimensions;
identifying a corresponding group of values for each of a set of dimensions such that each value of the group of values is associated with at least one available job posting in said repository, wherein said set of dimensions is contained in said plurality of dimensions; and
sending a user interface definition to a end user system, said user interface definition when rendered on a display unit of said end user system provides an input user interface to a job seeker, said input user interface containing a set of viewports, each viewport being associated with a dimension of said set of dimensions and showing the group of values identified for the associated dimension.

14. The machine readable medium of claim 13, further comprising one or more instructions for:
receiving an input request indicating selection of one or more values in said set of viewports;
determining a set of job postings matching said selection based on examining said repository, wherein said set of job postings is contained in said plurality of job postings;
forming, in response to said input request, a corresponding second group of values for each of said set of dimensions based on said set of job postings; and
updating said set of viewports on said display unit such that each viewport displays the second group of values for the associated dimension.

15. The machine readable medium of claim 13, wherein at a first time instance, said repository contains at least one job posting associated with a first value for a first dimension of said plurality of dimensions but contains no job postings associated with said first value for said first dimension starting at a second time instance following said first time instance,
wherein said first value is present in the corresponding group of values for said first dimension displayed in a first viewport between said first time instance and said second time instance,
wherein said first value is absent in the corresponding group of values for said first dimension displayed in said first viewport after said second time instance.

16. The machine readable medium of claim 15, wherein for a second dimension of said plurality of dimensions, the corresponding group of values contains only those values which are entered by different employers while adding said plurality of job postings to said repository, further comprising one or more instructions for:
for each of a third set of dimensions of said plurality of dimensions, inspecting said plurality of job postings to identify a plurality of buckets, each of said plurality of job postings being classified into one so of said plurality of buckets for the corresponding dimension of said third set of dimensions,
wherein the group of values for each dimension of said third set of dimensions comprises the labels of said plurality of buckets identified for the dimension.

17. The machine readable medium of claim 13, further comprising one or more instructions for:
storing a profile of said job seeker;
receiving, from said end user system, an indication of interest from said job seeker to view the job postings present in said job repository; and
determining, in response to said indication of interest, a subset of said plurality of job postings based on said profile of said job seeker,
wherein said identifying identifies said corresponding group of values for each of said set of dimensions such that each value is associated with at least one available job posting in said subset of said plurality of job postings,
wherein said sending sends said user interface definition in response to receiving said indication of interest.

18. A digital processing system comprising:
a processor;
a random access memory (RAM);
a machine readable medium to store one or more instructions, which when retrieved into said RAM and executed by said processor causes said digital processing system to enable job seekers to find suitable jobs, said digital processing system performing the actions of:
maintaining in a repository, a plurality of job postings organized with a plurality of dimensions, with each job posting being associated with respective values for one or more dimensions of said plurality of dimensions;
identifying a corresponding group of values for each of a set of dimensions such that each value of the group of values is associated with at least one available job posting in said repository, wherein said set of dimensions is contained in said plurality of dimensions; and
sending a user interface definition to a end user system, said user interface definition when rendered on a display unit of said end user system provides an input user interface to a job seeker, said input user interface containing a set of viewports, each viewport being associated with a dimension of said set of dimensions and showing the group of values identified for the associated dimension.

19. The digital processing system of claim 18, further performing the actions of:
receiving an input request indicating selection of one or more values in said set of viewports;
determining a set of job postings matching said selection based on examining said repository, wherein said set of job postings is contained in said plurality of job postings;
forming, in response to said input request, a corresponding second group of values for each of said set of dimensions based on said set of job postings; and
updating said set of viewports on said display unit such that each viewport displays the second group of values for the associated dimension.

20. The digital processing system of claim 18, further performing the actions of:
storing a profile of said job seeker;
receiving, from said end user system, an indication of interest from said job seeker to view the job postings present in said job repository; and
determining, in response to said indication of interest, a subset of said plurality of job postings based on said profile of said job seeker,
wherein said identifying identifies said corresponding group of values for each of said set of dimensions such that each value is associated with at least one available job posting in said subset of said plurality of job postings,
wherein said sending sends said user interface definition in response to receiving said indication of interest.
